(19) United States
(12) Patent Application Publication
(10) Pub. No.: US 2012/0163261 A1
(43) Pub. Date: Jun. 28, 2012

(54) TIMING MEASUREMENTS BETWEEN WIRELESS STATIONS WITH REDUCED POWER CONSUMPTION

(75) Inventors: RAMANUJA VEDANTHAM, ALLEN, TX (US); DERIC WAYNE WATERS, DALLAS, TX (US); ARITON E. XHAFA, PLANO, TX (US)

(73) Assignee: TEXAS INSTRUMENTS INCORPORATED, Dallas, TX (US)

(21) Appl. No.: 13/334,371

(22) Filed: Dec. 22, 2011

Related U.S. Application Data
(60) Provisional application No. 61/426,654, filed on Dec. 23, 2010.

(51) Int. Cl. H04W 52/02

(52) U.S. Cl. 370/311

(57) ABSTRACT

A method of obtaining timing parameters between wireless station peers using reduced power. A timing measurement protocol is executed a including a plurality of Timing Measurement Action (TMA) frames between a first wireless station (STA1) and a second STA (STA2) within a wireless network. The plurality of TMA frames span a communications interval and include timing information. A power-save protocol is employed by at least one of STA1 and STA2 during execution of the timing measurement protocol during one or more sub-intervals between the plurality of TMA frames. STA1 or STA2 computes at least one timing parameter using the timing information.

### CROSS REFERENCE TO RELATED APPLICATIONS

This application claims the benefit of Provisional Application Ser. No. 61/426,654 entitled “POWER EFFICIENT USAGE OF WLAN TIMING MEASUREMENT ACTION FRAME”, filed Dec. 23, 2010, which is herein incorporated by reference in its entirety.

### FIELD

Disclosed embodiments are directed, in general, to wireless communication systems, and more specifically to wireless networks that implement timing measurements between peer wireless stations in the network.

### BACKGROUND

As wireless technologies proliferate, wireless networks serving a plurality of wireless devices referred to herein as wireless stations (STAs) have begun to include a variety of applications that need to compute clock offset and time of flight (TOF) parameters between two STAs. Clock offset (CO) refers to the offset among different clock crystals used by the STAs, where the CO is generally measured in parts per million (PPM). Once CO is properly accounted for, TOF measurements enable each STA to accurately determine its position. Having CO information also allows synchronization of STAs that can also be important for example, for collision free access where timing between STAs needs to be accurate. Other applications for aligning CO include sharing a communications channel more efficiently by timing the usage of each STA better, or in a power saving protocol being able to wake-up at a given time more accurately. One class of STAs that can benefit from accurate STA′ location are STAs having both Global Positioning System (GPS) and WiFi devices.

Where the first and second STAs are peers with a peer-to-peer connection Timing Measurement Action (TMA) frames can be used to obtain CO and TOF parameters, where a series of packets are exchanged between the STAs to synchronize their respective clocks. The specification of IEEE 802.11v discloses a timing measurement protocol that enables a STA to measure its CO and the TOF relative to another peer STA and thus its distance relative to the other peer STA. See the IEEE 802.11v specification draft 14, section 11.22.5 (2011). The IEEE 802.11v specification draft 14 (2011) is referred to herein as “IEEE 802.11v”, which is hereby incorporated by reference into this application.

FIG. 1 summarizes the IEEE 802.11v disclosed timing measurement protocol between peer STAs. Other timing measurement protocols between peer STAs are known in the art. Frames 101 to 106 described below represent the frames involved in obtaining a single time measurement. The receiving STA (STA2) in need of assistance initiates a partnership with another STA (the sending STA; STA1) by transmitting a timing measurement request frame 101. STA1 acknowledges receipt of this frame in frame 102 and then sends a first timing measurement action (TMA) frame 103 including a time of departure (ToD) t1 for this frame. STA2 measures the time of arrival (TOA) for this frame (t2), then sends an immediate acknowledgement (ACK) frame 104 while measuring the TOD for this frame (t3). STA1 measures the TOA of the acknowledgement frame 104 as t4. STA1 sends a frame 105 including both t1 and t4 to STA2. STA2 thus now has t1, t2, t3, and t4 quantities which are related to both the CO (Δb) and the TOF assuming a symmetric channel between the respective STAs:

$$\begin{matrix}\begin{matrix}t 2 - t 1 = TOF + {b}_{Rx} - {b}_{Tx} \\ = TOF + Δ b\end{matrix} & ( 1 \text{-} 1 ) \\ \begin{matrix}t 4 - t 3 = TOF + {b}_{Tx} - {b}_{Rx} \\ = TOF - Δ b\end{matrix} & ( 1 \text{-} 2 )\end{matrix}$$

The CO (Δb) can be computed (here by STA2) as:

$$Δ b = \frac{( t 2 - t 1 ) - ( t 4 - t 3 )}{2} \qquad ( 1 \text{-} 3 )$$

and the TOF calculated as:

$$TOF = \frac{( t 2 - t 1 ) + ( t 4 - t 3 )}{2} \qquad ( 1 \text{-} 4 )$$

In the frame shown as 106, STA2 can send an optional ACK to STA1. Frames 107 and 108 show the first two frames of a subsequent time measurement using the same timing measurement protocol.

Using the IEEE 802.11v disclosed timing measurement protocol the respective STAs are both awake (i.e., their radios are on) during the full interval of time between frames 101 and 106. The time interval between frames 104 and 105 can be a long wait time, typically on the order of hundreds of ms, so that STA2 will consume significant power operating its radio while listening/waiting for packets from STA1. Moreover, there is generally a long idle wait time (e.g., on the order of seconds) between successive timing measurement procedures shown in FIG. 1 between frames 106 and 107, where again STA2 consumes significant power operating its radio while listening/waiting for packets from STA1.

### SUMMARY

Disclosed embodiments recognize wireless communication systems that include conventional timing measurement protocols between peer STAs that involve a plurality of Time Measurement Action (TMA) frames that span a communications interval suffer from high power use because the STA's listen/wait time for packets from each other during the communications interval can be long, and moreover the peer-to-peer connection setup time can be long. Both setup and listening/waiting consume significant power because the STA's radio is on throughout.

Disclosed embodiments include new timing measurement protocols that include a power-save procedure together with the TMA frames that improves power efficiency for implementing timing measurements between peer STAs. One disclosed embodiment combines timing measurement application with a Tunneled Direct Link Setup (TDLS) power-save procedure for peer-to-peer STA′ communications. Some embodiments also include rapid direct peer-to-peer connection setups for reducing power during setup for disclosed timing measurement protocols.

### BRIEF DESCRIPTION OF THE DRAWINGS

FIG. 1 summarizes the IEEE 802.11v timing measurement protocol between peer STAs.

FIG. 2 is a flow chart that shows steps in an example method of obtaining timing parameters between wireless station peers using reduced power, according to an example embodiment.

FIG. 3 depicts a TDLS setup, timing measurements performed between STA1 and STA2, and a TDLS teardown for these STAs, according to an example embodiment.

FIG. 4 is a block diagram representation of an example STA including a wireless transceiver and a processor implementing a disclosed reduced power timing measurement protocol, according to an example embodiment.

FIG. 5 is a block diagram depiction of an example wireless network that includes an access point (AP) and a plurality of STAs including a wireless transceiver and a processor implementing a disclosed reduced power timing measurement protocol including a STA acting as an optional soft-AP, according to an example embodiment.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

Disclosed embodiments include reduced power consumption timing measurement protocols for implementing timing measurements between peer STAs by including power-save protocols between TMA frames that improve power efficiency for the STAs for STA to STA (peer-to-peer) communications. In contrast, known power save procedures have only addressed reducing power consumption for communications between an AP and a STA, without concern for the STA's power consumption during STA to STA communications. Certain embodiments also save STA′ power by implementing more rapid direct peer-to-peer STA connection setups.

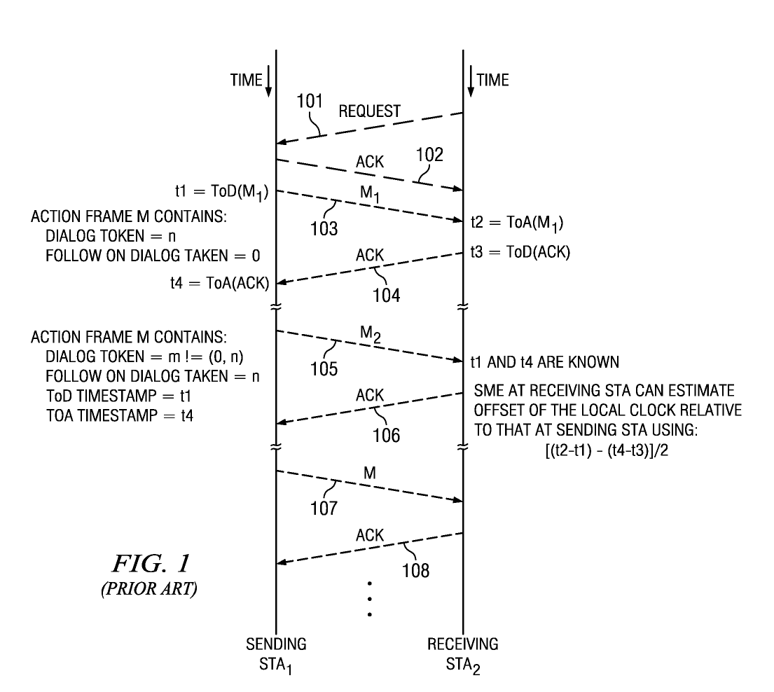

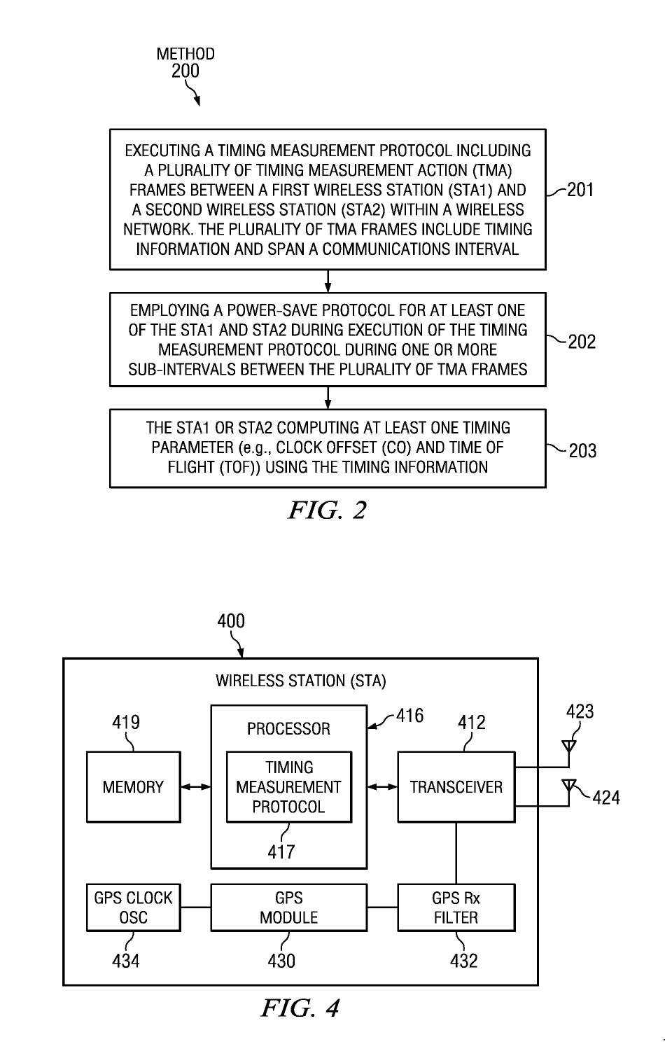

FIG. 2 is a flow chart that shows steps in an example method 200 of obtaining timing parameters between wireless station peers using reduced power, according to an example embodiment. Step 201 comprises executing a timing measurement protocol including a plurality of TMA frames between a first wireless station (STA1) and a second wireless STA (STA2) within a wireless network. The plurality of TMA frames include timing information and span a communications interval. Step 202 comprises employing a power-save protocol for at least one of the STA1 and STA2 during execution of the timing measurement protocol during one or more sub-intervals between the plurality of TMA frames. The power-save protocol may be applied to the IEEE 802.11v disclosed timing measurement protocol described above in FIG. 1, or other timing measurement protocols between peer STAs including those known in the art.

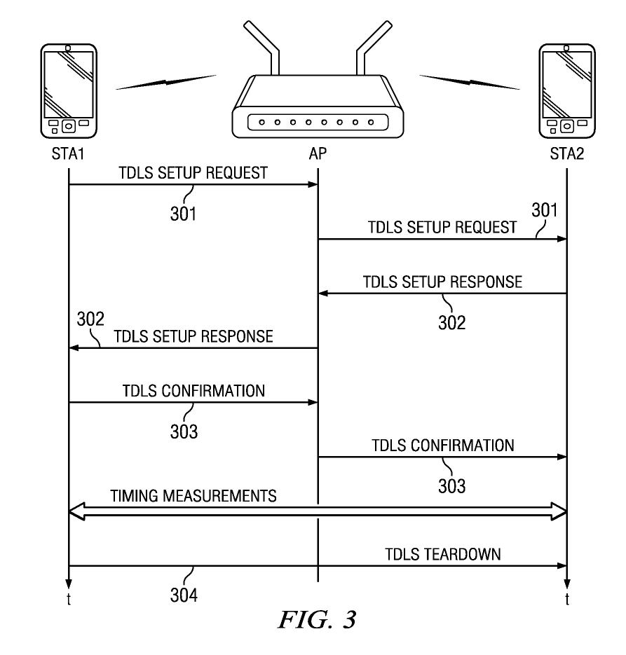

Step 203 comprises the STA1 or STA2 computing at least one timing parameter (e.g., clock offset (CO) and time of flight (TOF)) using the timing information. For example, using the IEEE 802.11v disclosed timing measurement protocol equations 1-1 to 1-4 shown above may be used to compute the CO and TOF. In one embodiment there are at least two STAs in the same base station subsystem (BSS), such as the arrangement shown at the top of FIG. 3 described below. In this scenario, at least two STAs (STA1 and STA2) are connected to the same AP, and the AP functions as the base station in a wireless local area network (WLAN).

In this embodiment, one STA can initiate a TDLS session with the other STA via the AP. TDLS is a wireless communication protocol that allows STAs to set up a direct link in the currently used WLAN environments in accordance with IEEE 802.11a/b/g/n. As used herein, IEEE 802.11a refers to an amendment that was published in the IEEE 802.11-2007 standard, IEEE 802.11b refers to an amendment that was published in the IEEE 802.11-2007 standard, IEEE 802.11g refers to an amendment that was published in the IEEE 802.11-2007 standard, and IEEE 802.11n refers to an amendment that was published in the IEEE 802.11-2009 standard. IEEE 802.11a/b/g/n are all hereby incorporated by reference into this application. In TDLS, the setup frames are encapsulated in data frames, as opposed to management frames, by encapsulating the payloads with an Ethertype, which allows the setup frames to be transmitted (tunneled) through the AP. The AP does not have to be TDLS aware, since the direct link setup tunnels protocol messages in data frames. Stations that setup a TDLS communication remain associated to the AP and have the option of transmitting frames directly to the TDLS peer station. TDLS is distinct and separate from Direct Link Setup (DLS) defined in IEEE 802.11e (IEEE 802.11e refers to an amendment that was published in the IEEE 802.11-2007 standard).

The TDLS stations can be initiated in the setup with a specific power-save mechanism enabled, such as peer power save mode (PSM scheduled) or peer unscheduled automatic power save delivery (U-APSD). The power save mechanism can be enabled through a TDLS setup request or response frame. A STA that intends to enter PSM (PSM initiator) can send a PSM Request frame to the peer STA (PSM responder), including a proposed periodic wakeup schedule. When the PSM responder accepts a proposed wakeup schedule, it can respond with a PSM response frame indicating a status code, such as a status code of 0 for successful. Otherwise the PSM responder can respond with a TDLS Peer PSM Response frame indicating the appropriate status code for rejecting the wakeup schedule. The wakeup schedule can remain valid until either the TDLS direct link is torn down, the STAs explicitly updating the existing wakeup schedule, or no MPDUs containing data have been exchanged for idle count consecutive awake windows. Once the STAs have established a TDLS session, the timing measurement protocol between the STAs can be executed once or multiple times.

The TDLS session allows the STAs to establish a direct peer-to-peer connection quickly, and use the connection through the AP for mainly transmitting control frames that are encapsulated as data frames from STA1→AP and AP→STA2, and vice versa. Since the STAs are already associated with the AP, the TDLS connection setup with the peer STAs can be performed quickly as specified in the 802.11z amendment. See IEEE 802.11z specification, Part 11, Amendment 7, August, 2010, which is hereby incorporated by reference into this application.

After the setup, a timing measurement protocol such as described above can be performed between the respective STAs through the direct TDLS link (no AP involved). If the timing measurement protocol is only executed once, the TDLS teardown procedure can be performed as specified in the 802.11z amendment to conserve power at both STAs.

Regarding TDLS teardown, to tear down a direct link, a TDLS peer STA can send a TDLS Teardown frame to the respective TDLS peer STA over the direct path. If the TDLS peer STA is unreachable via the TDLS direct link, the TDLS Teardown frame can be sent through the AP with appropriate reason code. If the TPK handshake was successful for this TDLS session, then the receiving STA can validate the MIC. If the MIC validation fails, the receiver can ignore the TDLS Teardown frame. A TDLS teardown frame is transmitted to all current TDLS peer STAs (via the AP or via the direct path) prior to transmitting a disassociation frame or a deauthentication frame to the AP, or after receiving a deauthentication frame or a disassociation frame from the AP.

An example TDLS procedure is illustrated in FIG. 3 which depicts a TDLS setup, timing measurements performed between peer STAs shown as STA1 and STA2, and a TDLS teardown for these STAs, with STA1 being described as the originator (without loss of generality), according to an example embodiment. A TDLS setup request frame 301 is shown sent by STA1 to the AP, and this frame 301 is sent by the AP to STA2. A TDLS setup response frame 302 is shown sent by STA2 to the AP, and the AP sends this frame to STA1. A TDLS confirmation frame 303 can be sent by STA1 to STA2 through the AP. STA1 and STA2 then perform a disclosed timing measurement protocol including a plurality of TMA frames, such as described above including a power-save protocol for STA1 or STA2 during execution of the timing measurement protocol during one or more sub-intervals between the TMA frames.

After the timing measurement protocol is completed, STA1 sends a TDLS teardown frame 304. Although not shown, STA2 can send an ACK confirming reception of the TDLS teardown frame, such as a MAC ACK confirmation. If an ACK is not received from STA2, STA1 can send the TDLS teardown frame through the AP.

On the other hand, if there is a need to perform timing measurement multiple times, such as when either of the STAs are mobile devices, or to improve accuracy by measuring multiple times, the TDLS Peer Power Save Mode (TDLS Peer PSM) power-save procedure can be used to reduce the power consumption during the idle wait time between successive timing measurement procedures, such as shown in FIG. 1 between frames 106 and 107. In this case, during the setup, the power-save indication method and the power-save parameters are exchanged, such as per the IEEE 802.11z specification, Part 11, Amendment 7, August, 2010. For example, in one example PS procedure, TDLS Peer PSM, has awake windows that are based on the Offset, Interval, Awake Window Slots and the Maximum Awake Window Duration. A simple TDLS peer example of this algorithm is described below.

In a first step STA1 and STA2 negotiate TDLS peer PSM parameters during setup. The TDLS peer PSM parameters can comprise initial wakeup including initial timing measurement time, periodicity of wakeup including periodicity of timing measurements, awake window slots including maximum awake window duration, and duration of the timing measurement procedure, when executed once. In a second step the timing measurement protocol is performed. In a third step the STAs doze, such as per TDLS Peer PSM. Dozing means that the STAs will turn their radios off for some time and “sleep” to save power. The method then returns to the second step where the timing measurement protocol is performed again. A TDLS teardown frame can be initiated by any of the two STAs to end the session.

In another embodiment, there are two STAs without a BSS. In this scenario one of the STAs can temporarily act as a Wi-Fi Direct Group Owner, also known in the art as a Soft AP. If the timing measurement procedure is to be repeated several times, the Wi-Fi Direct periodic Notice of Absence (NoA) power-save procedure can be leveraged to doze between any two successive instances of the timing measurement procedure. The NoA power-save procedure parameters can be negotiated either via NoA action frame or during the beacon transmissions by the STA acting as the Group Owner (Soft AP).

The NoA power-save procedure parameters can be include start time, interval, duration and count. The start time represents the time for initial doze, which can be set to begin at the end of first timing measurement procedure. The NoA interval can be set to periodicity of the timing procedure and the duration is set to the dozing period. Finally, the count field indicates the number of times this power-save procedure will be implemented. For example, a value of 255 (8 bits) can specify that this periodic dozing scheme will continue forever, until it is cancelled by a subsequent NoA action frame or beacon frame containing a different value for this parameter. It is note that all of these NoA parameter values are set with respect to the dozing periods, and not the active periods in contrast to the TDLS peer PSM-scenario described above.

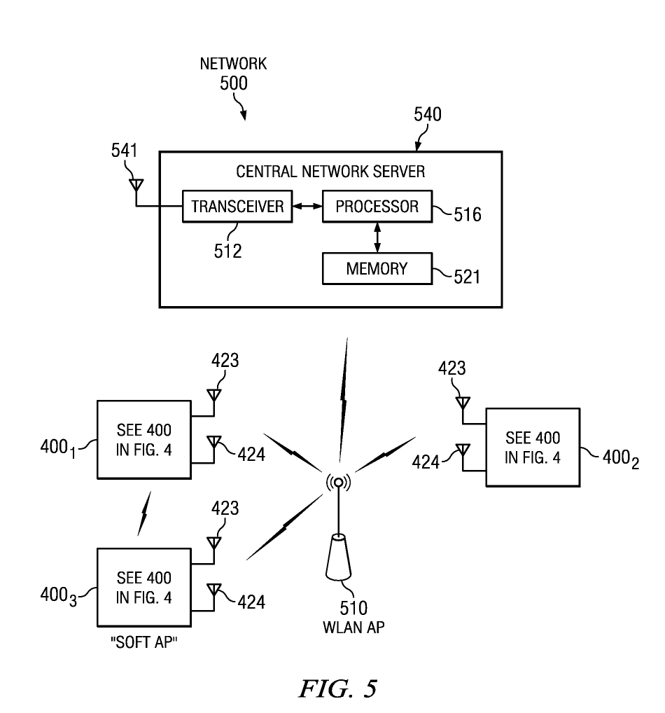

FIG. 4 is a block diagram representation of an example STA 400 shown as a WiFi plus GPS wireless STA 400 including a wireless transceiver 412 and a processor 416 implementing a disclosed reduced power timing measurement protocol algorithm according to an example embodiment. The transceiver 412 is coupled to an antenna 423, and the processor 416 has an associated memory 419 that stores a disclosed reduced power timing measurement protocol algorithm for processor 416 to implement a disclosed reduced power timing measurement protocol 417. STA 400 also includes a GPS clock oscillator 434 coupled to GPS module 430, where the GPS module 430 is coupled to the transceiver 412 through GPS Rx filter 432, and the transceiver 412 is also coupled to GPS antenna 424.

FIG. 5 is a block diagram depiction of an example wireless network 500 that includes a central network server 540, an AP 510 shown as a WLAN AP 510 for embodiments where the network 500 supports WLAN, and a plurality of STAs shown as WiFi plus GPS STAs 400₁, 400₂ and 400₃, according to an example embodiment. STA 400₃ is shown as a soft AP. Central network server 540 includes processor 516, memory 521, transceiver 512, and antenna 541. Although a single AP 510 is shown in FIG. 5, in typical wireless networks there are a plurality of APs.

There are at least two possible soft-AP scenarios. One scenario (not shown) involves a soft-AP and the STAs forming the network without the presence of the WLAN AP 510, or as shown in FIG. 5 STA 400₃ (Soft-AP) acts as a bridge between the WLAN AP 510 (or any other STA and the WLAN AP 510).

Although not shown, in one embodiment the STAs can comprise a wireless combination (combo) device that includes a first wireless transceiver communicating via a first wireless network and a second wireless transceiver communicating via a second wireless network that overlaps the first wireless network. For example, in one particular embodiment the first wireless network comprises a WLAN and the second wireless network comprises a wireless personal area network (WPAN). Example WPANs include Bluetooth (BT), as well as Zigbee and LTE which use the ISM band.

It should be appreciated that although this Disclosure has been described in the context of the IEEE 802.11 standard, this Disclosure is not limited to such contexts and may be utilized in various wireless network applications and systems, for example in a network that conforms to a standard other than IEEE 802.11. Furthermore, this Disclosure is not limited to any one type of architecture or protocol, and thus, may be utilized in conjunction with one or a combination of other architectures/protocols. For example, disclosed subject matter may be embodied in wireless networks conforming to other standards and for other applications, including other WLAN standards, Bluetooth, GSM, PHS, CDMA, and other cellular wireless telephony standards.

Many modifications and other embodiments of the invention will come to mind to one skilled in the art to which this invention pertains having the benefit of the teachings presented in the foregoing descriptions, and the associated drawings. Therefore, it is to be understood that embodiments of the invention is not to be limited to the specific embodiments disclosed. Although specific terms are employed herein, they are used in a generic and descriptive sense only and not for purposes of limitation.

We claim:

1. A method of obtaining timing parameters between wireless station peers using reduced power, comprising:
executing a timing measurement protocol including a plurality of Timing Measurement Action (TMA) frames between a first wireless station (STA1) and a second STA (STA2) within a wireless network, wherein said plurality of TMA frames span a communications interval and include timing information,
wherein a power-save protocol is employed by at least one of said STA1 and said STA2 during said executing of said timing measurement protocol during one or more sub-intervals between said plurality of TMA frames, and
said STA1 or said STA2 computing at least one timing parameter using said timing information.

2. The method of claim 1, wherein said wireless network includes an access point (AP), wherein said STA1 and said STA2 are connected to said AP, further comprising setting up a Tunneled Direct Link Setup (TDLS) session between said STA1 and said STA2 using said AP, wherein said TDLS session is used for said executing of said timing measurement protocol.

3. The method of claim 2, wherein said method further comprises specifying a power save mechanism to be enabled between said STA1 and said STA2 before or during said TDLS session.

4. The method of claim 3, wherein said power save mechanism comprises a peer power save mode comprising scheduled power-save management (PSM) or an unscheduled automatic power save delivery (U-APSD).

5. The method of claim 2, wherein when said timing measurement protocol is executed only once, further comprising performing a TDLS teardown procedure at said STA1 or said STA2 after said timing measurement protocol is executed.

6. The method of claim 2, wherein when said timing measurement protocol is executed multiple times, further comprising implementing a TDLS Peer Power Save Mode (TDLS Peer PSM) to reduce power consumption during an idle wait time between successive executions of said timing measurement protocol.

7. The method of claim 1, wherein one of said STA1 and said STA2 acts as a Wi-Fi Direct Group Owner (Soft AP) in said wireless network, and wherein said timing measurement protocol is executed multiple times, further comprising implementing a Wi-Fi Direct periodic Notice of Absence (NoA) power-save procedure to doze said STA1 and said STA2 between at least one successive instance of said timing measurement protocol.

8. The method of claim 7, wherein parameters for said NoA power-save procedure are negotiated by a NoA action frame or during a beacon transmissions by said STA2 while acting as said Soft AP.

9. The method of claim 8, wherein said parameters for said NoA power-save procedure include a start time, an interval, a duration and a count, wherein said start time represents a time for an initial doze, said interval being set to a periodicity of said timing measurement protocol and said duration being set to a dozing period, and wherein said count indicates a number of times said NoA power-save procedure is to be implemented.

10. A wireless station (STA), comprising:
a wireless transceiver coupled to an antenna;
a processor coupled to said transceiver having associated memory that stores computer executable instructions for a reduced power timing measurement protocol algorithm that when executed by said processor cause said processor to perform:
executing a timing measurement protocol including a plurality of Timing Measurement Action (TMA) frames between said STA and another STA within a wireless network, wherein said plurality of TMA frames span a communications interval and include timing information,
wherein a power-save protocol is employed by said STA during execution of said timing measurement protocol during one or more sub-intervals between said plurality of TMA frames.

11. The STA of claim 10, wherein said wireless network includes an access point (AP), wherein said STA and said another STA are connected to said AP, wherein said reduced power timing measurement protocol algorithm that when executed by said processor further causes said processor to perform a Tunneled Direct Link Setup (TDLS) session setup between said STA and said another STA using said AP, and wherein said TDLS session is used for said executing of said timing measurement protocol.

12. The STA of claim 11, wherein said reduced power timing measurement protocol algorithm that when executed by said processor further causes said processor to perform specifying a power save mechanism to be enabled between said STA and said another STA before or during said TDLS session.

13. The STA of claim 12, wherein said power save mechanism comprises a peer power save mode comprising scheduled power-save management (PSM) or a peer unscheduled automatic power save delivery (U-APSD).

14. The STA of claim 11, wherein when said timing measurement protocol is executed only once, said reduced power timing measurement protocol algorithm that when executed by said processor further causes said processor to perform a TDLS teardown procedure at said STA after said timing measurement protocol is executed.

15. The STA of claim 11, wherein when said timing measurement protocol is executed multiple times, said reduced power timing measurement protocol algorithm that when executed by said processor further causes said processor to perform implementing a TDLS Peer Power Save Mode (TDLS Peer PSM) to reduce power consumption during an idle wait time between successive executions of said timing measurement protocol.

16. The STA of claim 10, wherein one of said STA and said another STA act as a Wi-Fi Direct Group Owner (Soft AP) on said wireless network, and wherein said timing measurement protocol is executed multiple times, said reduced power timing measurement protocol algorithm that when executed by said processor further causes said processor to perform implementing a Wi-Fi Direct periodic Notice of Absence (NoA) power-save procedure to doze said STA between at least one successive instance of said timing measurement protocol.

17. The STA of claim 16, wherein parameters for said NoA power-save procedure are negotiated by a NoA action frame or during a beacon transmissions by said STA while acting as said Soft AP.

18. The STA of claim 10, further comprising a GPS module, wherein said GPS module is coupled to said transceiver and said transceiver is coupled to a GPS antenna, wherein said STA comprises a WiFi plus GPS STA.

19. A method of obtaining timing parameters between wireless station peers using reduced power, comprising:
setting up a Tunneled Direct Link Setup (TDLS) session between a first wireless station (STA1) and a second STA (STA2) using an access point (AP) within a wireless network;
executing a timing measurement protocol including a plurality of Timing Measurement Action (TMA) frames between said STA1 and said STA2, wherein said plurality of TMA frames span a communications interval and include timing information, and wherein said TDLS session is used for said executing of said timing measurement protocol;
wherein a power-save protocol is employed by at least one of said STA1 and said STA2 during said executing of said timing measurement protocol during one or more sub-intervals between said plurality of TMA frames, and
said STA1 or said STA2 computing at least one timing parameter using said timing information.

20. The method of claim 19, wherein said method further comprises specifying a power save mechanism to be enabled between said STA1 and said STA2 before or during said TDLS session, said power save mechanism comprising a peer power save mode comprising scheduled power-save management (PSM) or an unscheduled automatic power save delivery (U-APSD).
